(19) United States
(12) Patent Application Publication
(10) Pub. No.: US 2004/0187314 A1
(43) Pub. Date: Sep. 30, 2004

(54) Utility knife blade having an uneven cutting edge

(76) Inventor: Darian A. Johnson, Tamaroa, IL (US)

Correspondence Address: LEWIS, RICE & FINGERSH, LC, ATTN: BOX IP DEPT., 500 NORTH BROADWAY, SUITE 2000, ST LOUIS, MO, 63102, US

(21) Appl. No.: 10/796,761

(22) Filed: Mar. 9, 2004

Related U.S. Application Data
(60) Provisional application No. 60/453,452, filed on Mar. 10, 2003.

(51) Int. Cl. B26B 3/06; B26B 9/02

(52) U.S. Cl. 30/162; 30/355

(57) ABSTRACT

A blade for a utility knife provides a cutting edge that is undulate, toothed, or otherwise multiply edged, but is not designed to be used with a sawing motion, and, because of its short length, would not be practically used with a sawing motion. Such a blade allows for easier cutting of a wider range of materials, and allows for an extended useful lifetime as compared to a traditional flat-edged utility knife blade. Such a blade may be used in conjunction with a variety of utility knife housing designs, and may be provided for use in a method of cutting.

### BACKGROUND OF THE INVENTION

1. Field of Invention

The invention relates to utility knives and cutting blades for utility knives, more particularly to cutting blades having an uneven cutting edge and utility knives including the same.

2. Description of Related Art

Outside the arena of kitchen cutlery, the term utility knife commonly refers to a cutting tool comprising a cutting blade that is generally short, narrow, flat, and often easily replaceable from within a durable housing or handle. Utility knives have been widely used for many years to cut a broad variety of materials, primarily materials of minimal to moderate thickness and hardness, thus, occupying a general utility niche intermediate between that of scissors and a saw. The utility knife is not discretely limited to such a niche since a utility knife easily may be used to make cuts that could also be made with scissors, but there is almost no overlap with the primary utility of a saw.

A utility knife may be differentiated from other knives based on several characteristics of the utility knife, itself, and of its use. An important distinction is that the blade of a utility knife, or at least the practical usable portion thereof, generally is quite short and narrow compared with most other knives. Many utility knives have a usable cutting edge length of about 30 mm or less and a maximum thickness (generally on the side opposite the cutting edge) of about 1 mm. In some utility knives the blade is significantly longer than the length of the usable cutting edge, but in these knives only a short portion of the blade protrudes from the handle to produce the short cutting edge just described. As well, a utility knife blade traditionally has a straight or flat (as opposed to curved or angled) cutting edge. Based on these three characteristics—short, narrow, and flat—a blade used in a utility knife is commonly referred to as a razor blade, and a utility knife may be referred to as a razor knife. Additionally, almost universally, utility knife blades have a generally rectangular or trapezoidal shape, having four primary sides, all of which are straight—broadly, a quadrilateral shape. As a rectangle or trapezoid, the front side edge of the blade rises perpendicular to or at a fairly steep angle from the flat cutting surface, i.e., the front of the blade generally does not have a long narrow point.

As opposed to most other knife blades, the utility knife blade is generally held tightly by, but not permanently attached to, a metal or plastic housing that functions as a handle. Thus, the utility knife blade generally may be relatively easily replaced after opening the mount by which the blade is held to the handle or housing. Some utility knives, however, may be designed to be completely disposable, so that the blade is not easily removable.

In addition to the distinctions made based on the configuration of the blade, a utility knife generally may be distinguished from other knives with regard to its functions and its manner of use. A common (though not universal) functionality of utility knives allows for the retraction of the blade. A retracted position within the housing may be provided such that the blade is not exposed, thus, decreasing the risk of harm to the user and decreasing the risk of damage to the blade's sharp edge. To make the utility knife usable, from the retracted position a portion of the blade may be extended beyond the housing, exposing the sharp cutting edge.

Though not unique, it is characteristic of a utility knife that its most common manner of use is to push or pull the knife through the material being cut in a direction generally in the same direction as that of the cut through the material being cut, without substantially changing the depth of the blade within the material being cut (i.e., without “sawing”). As it is pushed through the material being cut, the cutting edge of the blade generally is held in a fairly constant position with respect to the surface of the material being cut, and generally at a smaller-than-perpendicular angle with respect to the direction of the cut.

In contradistinction to the most common manner of use of a utility knife (as just described), it is most common that other knives are used with a sawing motion, a chopping motion, or a stabbing motion. Of these, the sawing motion is by far the most common, and is a motion that is highly distinguishable from the motion most common to the use of a utility knife (as just described). For purposes of this disclosure, a sawing motion is defined as a motion where the length of the knife blade is drawn back and forth (or either back or forth) along the surface being cut in a direction that is generally perpendicular to the direction of the cut. The direction of the cut is generally perpendicular to a line along the length of the cutting edge of the knife. The back or forth motion is generally in a direction parallel to the line along the length of the cutting edge. Slicing of bread, for example, is a very common task in food preparation that uses such a sawing motion. In slicing bread, the knife is brought down upon the top of the loaf of bread, the bottom of which rests on the surface of a cutting board. The knife is drawn back and pushed forth along a direction generally parallel with the length of the blade (which is generally parallel to the cutting board), while the cut progresses from the top to the bottom of the loaf in a direction perpendicular to the surface of the cutting board (and perpendicular to the length of the knife blade). Generally, when using a sawing motion the knife blade passes entirely through the material being cut, constantly protruding from two sides of that material as the cut is made. This configuration allows for a smooth back and forth motion, wherein the front end of the knife blade (opposite the handle) is not forced to pass repeatedly into and out of the material being cut. For this reason, knife blades designed for use with a sawing motion are generally relatively long.

Sawing motions are very common with knives other than utility knives because where such a motion is permitted by the length of the blade, as it does with most knives, it is generally easier to make a cut using a sawing motion than to try to simply push a knife edge straight through a material in the direction of the cut (the common utility knife motion). Sawing motions, however, are particularly impractical with the short blade of a utility knife. With the short blade of a utility knife there is little advantage to the sawing motion because the length of the back or forth motion is so short. Very little cutting can be done using a utility knife with a sawing motion before the utility knife blade either comes out of the material being cut or is stopped by the handle impacting the material being cut (depending on whether the direction of the sawing motion is “back” or “forth”). With only a short motion permitted due to the short blade, the sawing technique is particularly inefficient with a utility knife.

Chopping is generally a very short motion in which a knife blade is held generally perpendicular to the direction of the cut, and is pushed through the material to be cut. Chopping could be performed by a utility knife, except that the design of “chopping” knives makes such a motion easier, for instance, because one's fingers are elevated compared with the cutting edge, which is not generally the case with a utility knife. Stabbing involves using the point of a knife to pierce the surface of the material being cut, but making a cut of little length. Knives with long narrow points at the front of the blade, unlike utility knife blades, are well designed for stabbing. Peeling (such as the peeling of an apple) is one common manner of use of other knives that does not usually involve a sawing, chopping, or stabbing motion, but is usually done by pulling the knife through the material being cut, not unlike the pulling motion commonly used with utility knives (although pushing is a safer motion). Again, however, as with chopping and stabbing, other knives are designed for more efficient peeling than are utility knives with their short flat blades.

The common manner of use of a utility knife has traditionally been an important factor in the design of the blade for a utility knife. Conventional wisdom (as explicated in trade publications) has long held that for the simple pushing (i.e., not sawing) motion utilized with cuts made with a utility knife, a plain, smooth cutting edge is most advantageous. The alternative to a plain edged blade is a blade having an undulating or toothed edge. Common experience supports conventional wisdom in identifying a toothed blade as excellent for use with a sawing or slicing motion. Consider kitchen cutlery as an example. Bread and tomato slicing knives, which are almost always used with a sawing motion, very often have toothed or undulate blades. Also, these knives having toothed or undulate cutting edges generally have long blades, which, as described above, is particularly beneficial for use with a sawing motion. A pairing knife, on the other hand, which is commonly used for peeling (a simple pushing motion), is nearly impossible to find without a plain edge and generally has a relatively short blade. It is in accord with the teaching of conventional wisdom, then, that a utility knife blade, a blade with a short cutting edge that is generally used with a simple pushing motion, has long been a flat, plain edged blade.

While not a tool for sawing cuts, the short cutting edge of utility knives otherwise provides such a general benefit that utility knives are broadly used on the job in many industries, as well as by individuals for personal and household projects. Examples of jobs in which people commonly rely on the benefits of utility knives are painters, carpenters, carpet layers, roofers, electricians, plumbers, and retail stockpersons. In one popular use the utility knife has taken on the moniker, box cutter, because it is so often used to open cardboard packaging boxes such as are used for an innumerable list of consumer and durable goods. The short blade of a utility knife provides a particular benefit in opening boxes since the blade does not protrude very far into the box and, therefore, generally does not damage the contents thereof. Other frequent uses for utility knives include cutting films or sheets such as are made of paper or plastic, including sheets of paper, paperboard, cardstock, and cardboard, and plastic films and coatings; durable materials such as nylon webbing; and gritty materials such as sheetrock (drywall) that quickly dull the blade.

While providing many benefits, the traditional utility knife has disadvantages. One disadvantage of the utility knife stems from the wide variety of uses people make of the tool as a result of its convenience. The utility knife is a generally easy to use and safe tool, causing people to use it in such a wide range of cutting environments that it invariably provides less utility in some cutting endeavors than others. While it may be the best tool on hand for a particular cutting job, it may still prove difficult to make the desired cut. Though utility knives are commonly used for cutting very tough materials such as carpet, the backing of which is a very strong, dense, fibrous material, such use may prove to be difficult with a utility knife having a traditional short, narrow, and flat blade. This traditional shape is not the best shape for all types of pushing cuts.

While the shape of a traditional utility knife blade may be a disadvantage for some tasks, what may be a primary disadvantage of most utility knives is the rate at which the blades must be replaced due to their becoming dull. Clearly a sharp blade is advantageous for providing ease in making cuts. Because of their usefulness and convenience, however, utility knives are used often, and are often used to cut durable, blade-dulling materials. Due to this punishing use, utility knife blades dull fairly quickly causing users to frequently change the blade.

In the face of the long felt need for durable utility knife blades, manufacturers of such blades have continuously sought to improve the qualities of the materials from which these blades are produced. As applicable advancements are made in materials science, such advancements have been transferred into the making of cutting tools, including utility knife blades. Thus, as they are developed, harder metal alloys and alloys that hold an edge longer have been introduced as the raw materials from which utility knife blades are made. Also, ceramic materials that demonstrate better wear characteristics have been used in the manufacture of utility knife blades. Other than material advances, however, the short, narrow, and flat design of utility blades has changed little over time.

### SUMMARY OF THE INVENTION

In response to the disadvantages of the traditional, short, narrow, and flat utility knife blade discussed above, a blade has been developed for use in a utility knife, which blade is not flat and straight. An embodiment of a blade of the present invention provides a cutting edge that is undulate, toothed, or otherwise multiply edged (here, termed “uneven”). Such an embodiment allows for easier cutting of a wider range of materials, and allows for an extended useful lifetime as compared to a traditional flat-edged utility knife blade. Whereas blades have been developed for other knives (such as bread slicers) that are undulate, toothed, or otherwise multiply edged, as discussed above, these other blades have been developed for use with a sawing motion. An uneven edged blade of an embodiment of the present invention, however, is not designed to be used with a sawing motion, and, because of its short length, would not be practically used with a sawing motion. The uneven edged blade of an embodiment of the present invention, rather, does provide added endurance to the usefulness of the utility knife blade, thereby providing a solution to a problem long addressed solely through other characteristics of the blade, primarily its material composition. Additionally, the uneven blade of embodiments of the present invention may be especially helpful in cutting through tough materials. While undulate, toothed, or otherwise multiply edged (“uneven”) knife blades have been known for some time they have never been applied to utility knives since conventional wisdom has held the flat edge most useful in the context of utility knives.

An embodiment of the invention is a cutting blade for use in a utility knife, the blade including a left side and a right side that are generally parallel to one another and have a thickness therebetween, the left side and the right side being generally mirror image quadrilaterals; a front edge and a back edge; and an uneven cutting edge that is different from the front edge and the back edge, and that lies in a plane that is generally parallel to the planes defined by the left side and the right side. In this embodiment the cutting blade provides a cutting edge of less than about 60 mm, and is intended to be disposable. In alternate embodiments the left side and the right side may be generally trapezoidal in shape, or may be generally rectangular in shape. In another embodiment the cutting blade is designed to be mounted in a utility knife housing and is designed to be removable from a the utility knife housing after the cutting blade has been so mounted. In a preferred embodiment the thickness of such a cutting blade is less than about one and one half millimeters, and the longest length of a side of the cutting blade is less than about 60 millimeters.

In a further embodiment the uneven cutting edge of the cutting blade comprises at least one point that is a local minimum along the cutting edge such that other positions along the cutting edge immediately adjacent to the one point occupy an elevated position relative to a plane containing the one point oriented perpendicular to the planes generally defined by the left side and the right side of the cutting blade. While the number of the such points is not limited, the number is preferably in the range between and including four and twenty, and most preferably is exactly eight. Such points may be equally spaced from one another along the cutting edge. For a cutting blade comprised of such points, the cutting edge between the points may traverse a smooth arc of the shape of one of a circle, an ellipse, a hyperbola, and a parabola, or may be any other shape.

Another embodiment of the invention is a utility knife including a cutting blade, which cutting blade includes: a left side and a right side that are generally parallel to one another and have a thickness therebetween, the left side and the right side being generally mirror image quadrilaterals, a front edge and a back edge, and an uneven cutting edge that is different from the front edge and the back edge, and that lies in a plane that is generally parallel to the planes defined by the left side and the right side; and a housing to which the cutting blade is mounted, the housing having a length for use as a handle by which one grips the utility knife. In such a utility knife the cutting blade is intended to provide a short cutting edge extending beyond the housing by less than about one fourth of the length of the housing, and is intended to be disposable. In an alternate embodiment of a utility knife of the present invention, the blade is intended to be replaceable within a reusable utility knife housing. The cutting edge of the blade may also be repeatably retractable into the housing and extendable from within the housing of the utility knife.

A still further embodiment of the present invention includes a method of cutting, which method includes providing a cutting blade that has a left side and a right side that are generally parallel to one another and have a thickness therebetween, the left side and the right side being generally mirror image quadrilaterals, a front edge and a back edge, and an uneven cutting edge that is different from the front edge and the back edge, and that lies in a plane that is generally parallel to the planes defined by the left side and the right side. The method continues by puncturing a surface of an object to be cut, then the cutting blade is moved using only one of a pushing and pulling motion in a direction generally parallel to the direction of the cut.

### BRIEF DESCRIPTION OF THE FIGURES

FIG. 1 shows a perspective view of a utility knife having an uneven edged blade.

FIG. 2 shows a perspective view of a utility knife blade having an uneven cutting edge.

FIG. 3 shows a planar elevation of the blade of FIG. 2 from the left side.

FIG. 4 shows a planar elevation of the blade of FIG. 2 from the cutting edge.

FIG. 5 shows a planar elevation of the blade of FIG. 2 from the top side.

FIG. 6 shows a planar elevation of the blade of FIG. 2 from the front edge.

FIG. 7 shows a cross sectional view of the blade of FIG. 2.

FIG. 8 shows a cross sectional view of an alternate embodiment to the blade shown in FIG. 7.

FIGS. 9-11 show alternate embodiments of the blade shown in FIG. 3.

FIGS. 12-13 show alternate embodiments of the utility knife and blade shown in FIG. 1.

### DETAILED DESCRIPTION OF PREFERRED EMBODIMENTS

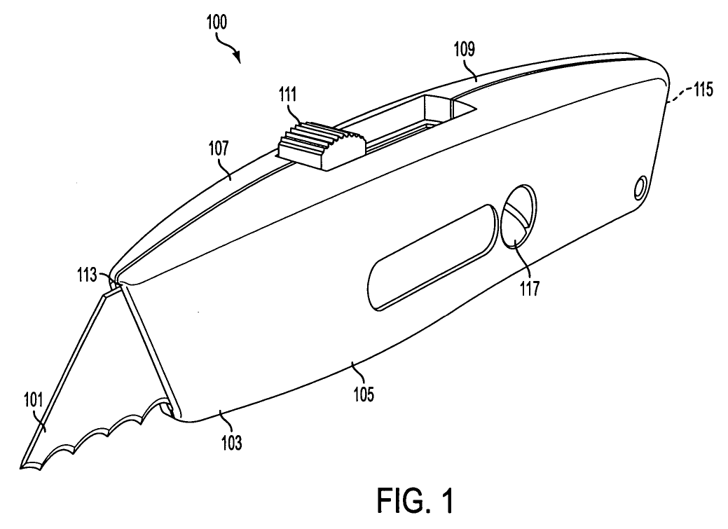

FIG. 1 shows an embodiment of the invention wherein an uneven edged blade (101) has been mounted in a traditional utility knife housing (103). The utility knife housing (103) is comprised of two halves, a left side (105) and a right side (107), which are mated together and held in place with the aid of a screw (117). Along the top side (109) of the utility knife housing (103) is the blade extension lever (111). The blade extension lever (111) is connected to the mount (not shown) for the utility knife blade (101). The blade extension lever (111) can be moved by a user of the utility knife (100) by sliding the blade extension lever (111) toward the front (113) of the utility knife (100) or toward the back (115) of the utility knife (100). Through the connection of the blade extension lever (111) to the mount for the blade (101), movement of the blade extension lever (111) moves the blade (101) in the same direction that the blade extension lever (111) is moved. Thus, by moving the blade extension lever (111) toward the front (113) of the utility knife (100), the blade may be extended in front of the utility knife housing (103), while movement in the opposite direction may retract the blade (101) to within the utility knife housing (103). This type of utility knife housing has been described in earlier patents, including U.S. Pat. No. 4,005,525, the entire disclosure of which is herein incorporated by reference in its entirety.

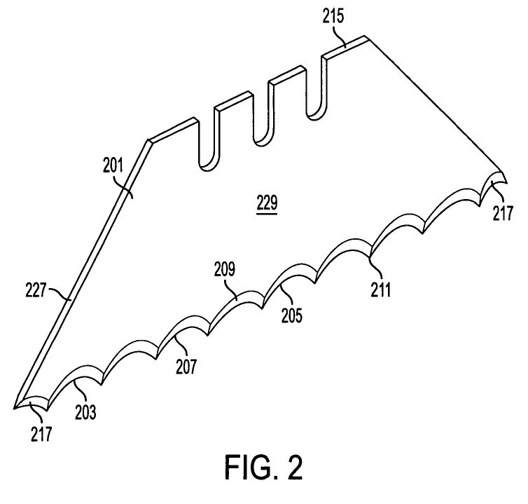

FIG. 2 shows an embodiment of the invention that is a utility knife blade (201) having a generally trapezoidal shape and comprising an uneven cutting edge (203) along its bottom side (205), which is the longest side of the trapezoid. Wherein the utility knife blade (201) is designated as having top side (215) and a front edge (227), the broad, trapezoidal side (229) exposed in this FIG. 2 is the left side (229). In this embodiment the uneven cutting edge (203) is comprised of a series of arcs (207) each having a beveled face (209), wherein all of the arcs (207) have the same radius of curvature, and all arcs (207), except the two arcs (217) on either end of the series of arcs (207), have equal length. The arcs (207) meet at points (211) of intersection, each of which are equidistant from one another.

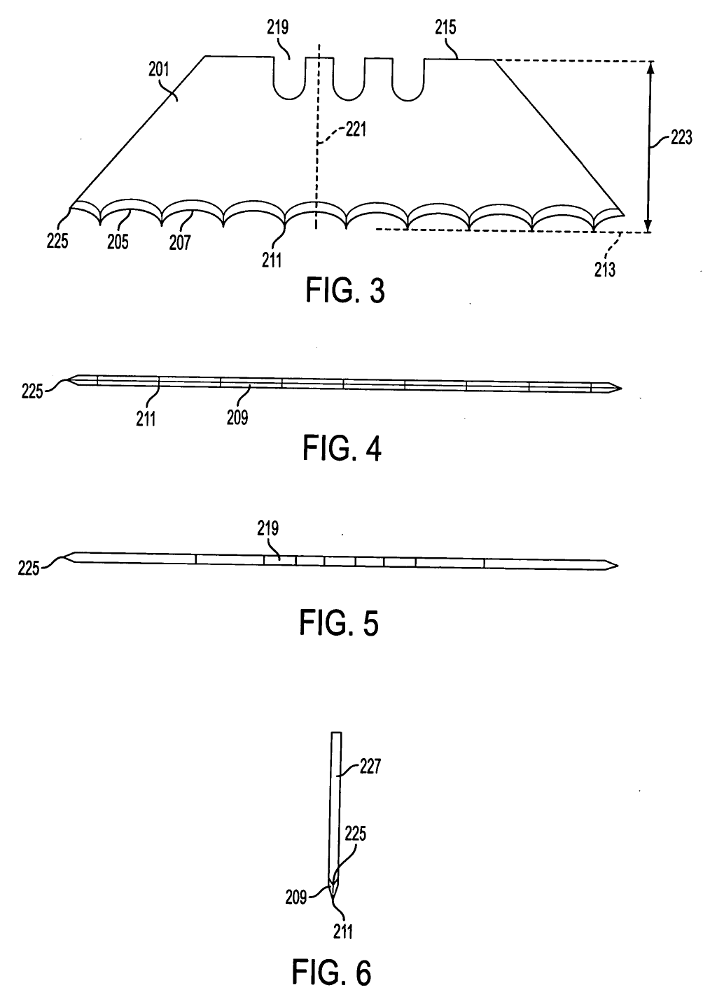

FIG. 3 shows a planar elevation view of the blade (201) shown in FIG. 2. As seen in FIG. 3, the arcs (207) can be thought of as having been ground from a formerly straight edge such that each of the points (211) lies along an imaginary straight line (213) that, along with the top side (215) of the blade (201), defines the greatest height (223) of the blade (201). As the line (213) defines the greatest height (223) of the blade (201), and the line (213) contains each of the points (211), each of these points (211) of intersection is a local minimum in the space defined by the blade, i.e., positions along the cutting edge (203) that are immediately adjacent to a point (211) are of greater height relative to the top side (215) of the blade (201) than are the points (211), themselves.

In this embodiment there are eight, equal length arcs (207) that are centered along the length of the bottom side (205) of the blade (201). The number of equal length arcs (207) is not limited to eight, but may be any number, though the number of equal length arcs (207) along the cutting edge is preferably in the range from four to twenty. In the embodiment shown in FIGS. 2 and 3, because the length of the bottom side (205) of the blade (201) is greater than the length traversed by the eight arcs (207), the uneven cutting edge (203) includes two partial arcs (217) of smaller length but having the same radius of curvature as the eight equal length arcs (207). The shorter arcs (217) on either end of the cutting edge are not necessary to an embodiment of the present invention. An uneven edged blade may comprise a cutting edge in which the equally spaced points (211) traverse a distance that is the exact length of the bottom side (205) of the blade (201), so that no partial arcs (217) are present. A potential advantage of a partial arc (217) at the end of the cutting edge is the creation of a point (225) that is easier to use in the event that the utility blade (201) is used in a stabbing motion. A blade without partial arcs (217) may provide greater safety because the points (225) on the ends of the blade (201) would point downward as do the points (211) and may not be as easy to accidentally use for stabbing.

A key feature of embodiments of this invention is the uneven cutting edge (203) of the cutting blade (201). Whereas FIG. 2 shows an embodiment in which the uneven cutting edge (203) is comprised of arcs (207), there is no limit to the shape of the uneven cutting edge (203) of a utility blade (201) embodying this invention. Where arcs (207) embody the uneven cutting edge (203), the arcs (207) may be of any general shape, such as circular, elliptical, hyperbolic, and parabolic arcs. As well, embodiments of the present invention include uneven cutting edge utility knife blades (201) that comprise a cutting edge (203) having a series of arcs (207), some of which are of a different description, that is, cutting blades (201) having arcs (207) separately described as any two or more of circular, elliptical, hyperbolic, and parabolic arcs. For a blade (201) that has arcs (207) of such varying description, the pattern of different arcs (207) in the series of arcs (207) along the bottom side (205) of the blade (201) may be either regular or irregular, that is having or not having a sub-series of arcs (207) that repeats along the length of the blade (201).

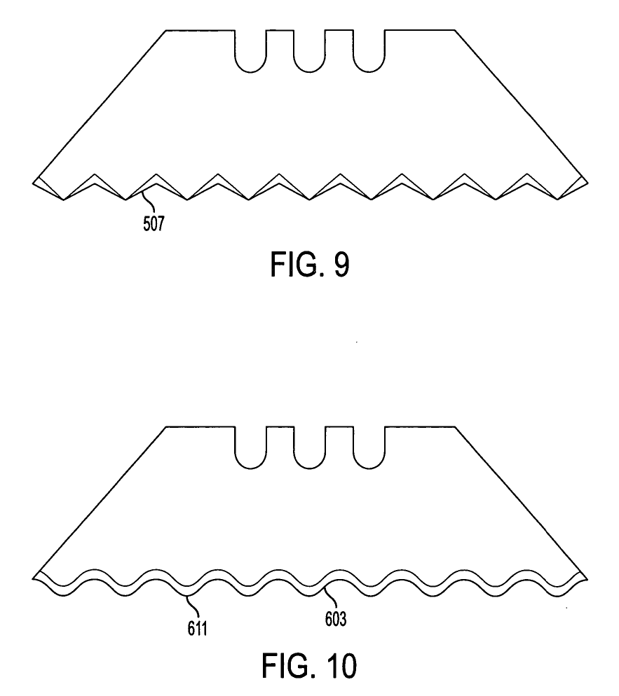

In addition to an uneven cutting edge (203) comprised of points (211) that result from the intersection of arcs (207) as shown in FIG. 2, points (211) on the uneven cutting edge (203) may be separated by a cutting edge (203) of essentially any shape (not just arcs), including sections of the cutting edge (203) between points (211) that are variously curved and sections that are straight. For example, in an embodiment an uneven cutting edge is comprised of a series of triangular indentations as shown in FIG. 9, an embodiment that can be conceived of as one in which the arcs (207) of FIG. 2 have been replaced by intersecting straight lines (507). A further embodiment, shown in FIG. 10, is comprised of what may be referred to as rounded points (611). The uneven cutting edge (603) of FIG. 10 is generally sinusoidal in nature.

FIG. 2 shows three notches (219) in the top side (215) of the cutting blade (201). These notches (219) are designed to be used for holding the blade (201) in a blade mount (not shown) within the housing (103) of a utility knife as shown in FIG. 1. Some blade mounts used in utility knives (100) require more or fewer notches (219) than three, or deeper or shallower notches (219) than shown in FIG. 2; and some mounts require one or more holes (not shown) through the thickness of the blade (201) between the right and left sides. Whereas various blade mounts may be used in various housing designs, embodiments of the present invention include blades (201) that have no notches (219) or holes, as well as blades (201) that have various configurations of notches (219) and holes designed to mate with the various designs of utility knife housings now known or later developed.

FIGS. 4-6 show elevation views of various ends and sides of the utility knife blade (201). FIG. 4 is a view in elevation of the uneven cutting edge (203). Viewed from this angle, the points (225) at the front and back edges, the points (211), and the beveled faces (209) of the arcs (207) are observable. FIG. 5 shows an elevation view of the top side (215) of the blade (201). From this view the notches (219) and the points (225) are seen. FIG. 6 is an elevation view of the front edge (227) of the blade (201). This figure shows a point (225), a point (211), and the beveled face (209) of the shorter arc (217).

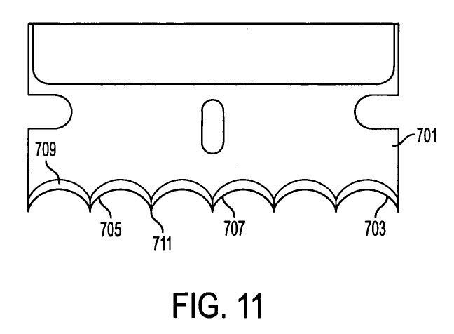

Alternate embodiments of a utility knife blade of the present invention may be shaped other than as the trapezoidally shaped blades shown in FIGS. 2 and 3. FIG. 11 depicts a generally rectangular utility knife blade (701) having an uneven cutting edge (703) along the bottom side (705) of the blade (701). Just as in FIG. 2, in this embodiment the uneven cutting edge (703) is comprised of a series of arcs (707) having a beveled face (709), wherein all of the arcs (707) have the same radius of curvature, and except for the two arcs (717) on either end of the blade (701), all have equal length. As well, the arcs (707) meet at points (711) of intersection, each of which are equidistant from one another. As was described above in relation to FIG. 2, the cutting edge (703) of an alternate embodiment of a rectangular blade (701) may be comprised of any of various geometries that result in an uneven cutting edge (703), including cutting edge segments that are variously curved or straight.

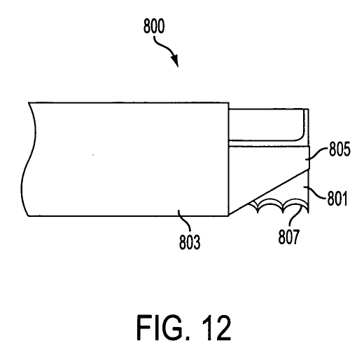

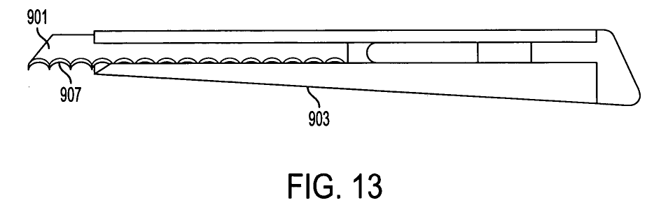

FIGS. 12 and 13 depict alternate embodiments of utility knives of the present invention as examples of utility knives in which utility knife blades of configurations other than the generally trapezoidal blade of FIG. 2 may be used. FIG. 12 depicts a utility knife (800) having a narrow metal housing (803) that encloses a mount (805) for a generally rectangular blade (801) like that depicted in FIG. 11. The mount (805) provides a slot into which the blade (801) can be placed. A corner of the mount (805) is open to expose the cutting edge (807) of the blade (801).

FIG. 13 depicts an alternate embodiment of a utility knife (900) in which the blade (901) is longer than those previously discussed, but is none the less mounted in a utility knife housing (903) in such a way that only a short cutting edge (907) is intended to protrude beyond the housing (903) during normal use. This embodiment utilizes a blade (901) that is designed so that relatively short lengths of the blade can be snapped off by hand and discarded once such a length has become dull. Snapping off a length allows an unused length of the blade (901) to be extended from within the housing (903), such unused length having a sharp edge (907). Utility knife housing designs such as those depicted in FIGS. 1, 12, and 13 are well known to those of ordinary skill in the art.

Generally trapezoidal embodiments of the present invention encompass utility knife blades that are within the following dimensions: 50 mm x 25 mm x 1 mm. Embodiments are not so limited, however, and may be scaled up or down (not necessarily proportionately) to fit within variously designed utility knife housings now known or later developed.

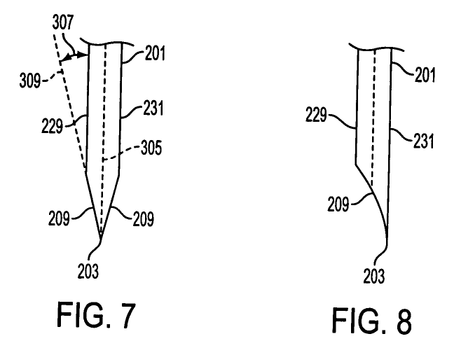

Shown in FIG. 7 and 8 are alternate embodiments of the present invention as viewed in cross section along the line (221) shown in FIG. 2, as if looking toward the front edge (227). FIGS. 7 and 8 show that in alternate embodiments the cutting edge (203) may be ground from both sides of the blade (201) as shown in FIG. 7, or only from one side of the blade (201) as shown in FIG. 8. FIG. 7 shows a cutting edge (203) that has been ground equally from the left side (229) and right side (231) of the blade (201), so that the cutting edge (203) lies along a line (305) equidistant from both sides (229 and 231). When the cutting edge (203) is ground from both sides as in FIG. 7, there will be beveled faces (209) on each side of the cutting edge (203). FIG. 8 shows a cutting edge (203) that has been ground only from the left side (229) of the blade (201). In the embodiment of FIG. 8, the cutting edge (203) is in line with the right side (231) of the blade (201). Whether the cutting edge (203) is sharpened from both sides or just one side, the beveled face (209) of the cutting edge (203) may be curved, including convex curves and concave curves, the latter of which is shown in the beveled face (209) of FIG. 8, or may be flat as shown in FIG. 7, such that the blade (201) narrows to the cutting edge (201) at a constant angle (307). When the beveled face (209) is flat, the grinding angle (307) is defined as the angle between a side (229 and 231) of the blade (201) and a line (309) parallel with the beveled face (209) of the cutting edge (203). In embodiments of the present invention, the grinding angle (307) may be any angle, but is preferably between 5 degrees and 40 degrees, and more preferably between 10 degrees and 25 degrees.

Embodiments of the utility knife blade (201) may be manufactured from any appropriate material for the making of a cutting blade, which material generally should be hard, durable, non-brittle, and non-corrosive. An example of a common material for manufacture of an embodiment is a steel alloy, such as the alloy commonly referred to as carbon steel. Various steel alloys may be appropriate since any particular alloy may have better qualities than another alloy for a particular application of a utility blade. Various metallic materials other than steel alloys also may be appropriate, as well as may be ceramic materials. Other materials, either now known or later developed or discovered, may be suitable for making an embodiment of this invention.

While the invention has been disclosed in connection with certain preferred embodiments, such disclosure is not intended to and should not be construed so as to limit the invention to only those elements and relationships described, nor to all of the elements and relationships described. Modifications and variations of the described embodiments may be made without departing from the spirit and scope of the invention, and other embodiments should be understood to be encompassed in the present disclosure as would be understood by those of ordinary skill in the art.

1. A cutting blade for use in a utility knife comprising:
a left side and a right side that are generally parallel to one another and have a thickness therebetween, said left side and said right side being generally mirror image quadrilaterals;
a front edge and a back edge; and
an uneven cutting edge that is different from said front edge and said back edge, and that lies in a plane that is generally parallel to the planes defined by said left side and said right side;
wherein said cutting blade provides a cutting edge of less than about 60 mm; and
wherein said cutting blade is also intended to be disposable.

2. A cutting blade of claim 1, wherein said left side and said right side are generally trapezoidal in shape.

3. A cutting blade of claim 1, wherein said left side and said right side are generally rectangular in shape.

4. A cutting blade of claim 1, wherein said cutting blade is designed to be mounted in a utility knife housing and is designed to be removable from a said utility knife housing after said cutting blade has been so mounted.

5. A cutting blade of claim 1, wherein said uneven cutting edge comprises at least one point that is a local minimum along the cutting edge such that other positions along the cutting edge immediately adjacent to said one point occupy an elevated position relative to a plane containing said one point oriented perpendicular to the planes generally defined by said left side and said right side of said cutting blade.

6. A cutting blade of claim 5, wherein the number of said points is in the range between and including four and twenty.

7. A cutting blade of claim 6, wherein the number of said points is exactly eight.

8. A cutting blade of claim 6, wherein said points are equally spaced from one another along said cutting edge.

9. A cutting blade of claim 6, wherein the cutting edge between said points traverses a smooth arc of the shape of one of a circle, an ellipse, a hyperbola, and a parabola.

10. A cutting blade of claim 1, wherein said thickness is less than about one and one half millimeters.

11. A cutting blade of claim 10, wherein the longest length of a side of said cutting blade is less than about 60 millimeters.

12. A utility knife comprising:
a cutting blade comprising:
a left side and a right side that are generally parallel to one another and have a thickness therebetween, said left side and said right side being generally mirror image quadrilaterals;
a front edge and a back edge; and
an uneven cutting edge that is different from said front edge and said back edge, and that lies in a plane that is generally parallel to the planes defined by said left side and said right side; and
a housing to which said cutting blade is mounted, said housing having a length for use as a handle by which one grips said utility knife; and
wherein said cutting blade is intended to provide a short cutting edge extending beyond said housing by less than about one fourth of said length of said housing; and
wherein said cutting blade is intended to be disposable.

13. A utility knife of claim 12 wherein said blade is intended to be replaceable within a reusable utility knife housing.

14. A utility knife of claim 12 wherein said cutting edge of said blade is repeatably retractable into said housing and extendable from within said housing.

15. A method of cutting comprising:
providing a cutting blade comprising:
a left side and a right side that are generally parallel to one another and have a thickness therebetween, said left side and said right side being generally mirror image quadrilaterals;
a front edge and a back edge; and
an uneven cutting edge that is different from said front edge and said back edge, and that lies in a plane that is generally parallel to the planes defined by said left side and said right side;
puncturing a surface of an object to be cut; and
moving said cutting blade using only one of a pushing and pulling motion in a direction generally parallel to the direction of the cut.
